(19) United States
(12) Patent Application Publication
(10) Pub. No.: US 2018/0143940 A1
(43) Pub. Date: May 24, 2018

(54) DATA PROCESSOR

(71) Applicant: ADAPTIVE ARRAY SYSTEMS LIMITED, Daresbury Cheshire (GB)

(72) Inventors: Christopher SHENTON, Nantwich Cheshire (GB); Finbar NAVEN, Cheadle Hulme Cheshire (GB)

(73) Assignee: Adaptive Array Systems Limited, Nantwich Cheshire (GB)

(21) Appl. No.: 15/568,428

(22) PCT Filed: Apr. 19, 2016
(86) PCT No.: PCT/GB2016/051076

§ 371 Date: Oct. 20, 2017

(30) Foreign Application Priority Data
Apr. 21, 2015 (GB) 1506766.3

(51) Int. Cl. G06F 15/80

(52) U.S. Cl. CPC G06F 15/8023; G06F 9/3885

(57) ABSTRACT

A data processor is described which comprises a sequence of processing stages, each processing stage comprising a plurality of processing elements, each processing element comprising an arithmetic logic unit, one or more input data buffers and one or more output data buffers, the arithmetic logic unit being operable to conduct a data processing operation on one or more values stored in an input data buffer and to store the result of the data processing operation into an output data buffer. Between each pair of processing stages in the sequence, an interconnect is provided, for conveying data values stored in the output data buffers of the processing elements in a first one of the processing stages in the pair to the input data buffers of the processing elements in the next processing stage in the pair. A controller is provided, which is operable to specify, in respect of each processing stage, a data processing operation to be carried out by the processing elements in that processing stage, and to specify, in respect of each interconnect, a routing from one or more of the output data buffers of one or more of the processing elements of the processing stage from which the interconnect is receiving data to one or more of the input data buffers of one or more of the processing elements of the processing stage to which the interconnect is conveying data.

### FIELD OF THE INVENTION

The present invention relates to a data processor. Embodiments of the present invention relate to a data processor having a sequence of processing stages.

### BACKGROUND TO THE INVENTION

Applications that require real time processing of highly complex systems are currently restricted to approaching the related computational problems using processors such as FPGA (field-programmable gate array—which offers the flexibility of a programmable architecture but at the cost of slower operation and high power consumption) and ASIC (application-specific integrated circuit—which can operate fast at a low overhead but are unable to be customized to optimise certain tasks). It would be highly desirable to be able to provide a general purpose real-time “phased array” processing architecture that is capable of operating in both the time and frequency domains with significant improvements in processing flexibility and overhead.

More particularly, it would be desirable to provide high resolution, broadband array processing which permits the development of next generation systems within the scope of a small footprint, low power and low cost solution. This would enable system developers to provide increased capability at the same time as achieving reductions in system costs, processing real estate requirements, power demands and complexity of system development processes.

In cases where frequency domain processing in the digital domain is advantageous, there does not currently exist an efficient processor architecture that is able to operate without a hugely significant overhead in both processing time and limited flexibility. One example of such problems where an architecture such as this would be particularly advantageous is in beamforming. The general principle of beamforming using phased arrays has been around since the 1940's. It is used in many kinds of systems such as RADAR and SONAR, and it is a very well understood technique. The summation of signals can be achieved in purely analogue circuits as well as in the digital domain. In practice a number of factors come into play, which have an impact on the ‘quality’ of the formed beam. These include non-ideal gain characteristics of elements, performance tolerance within analogue signal paths, the physical relationship between elements, and the propagation characteristics of the signal through the spatial medium. Beamforming can become very computationally intensive, since the processing requirement scales as a function of the number of elements squared.

Beamforming in the frequency domain can be advantageous for high resolution control of beams or signal equalisation. However, frequency domain processing in the digital domain is a very significant processing task. Currently this process requires a High-Performance Computing (HPC) cluster or a supercomputer platform to achieve meaningful results, which makes it impractical for most commercial applications due to footprint, cost and power demands. Current processing technologies have limitations in such applications due to trade-offs required to optimise in one area at the cost of another.

FPGAs share the use of a customisable processing array that has its function set by a pre-coded instruction word; however they provide this flexibility at the expense of a high level of transistor redundancy (and therefore high unit costs) and a limited optimization of clock cycles. This leads to sub-optimal levels of power consumption.

Digital Signal Processors (DSPs) often perform similar applications to those intended to be covered by the invention. These processors have their functionality hard wired which allows power and time for operation to be optimised, and in simple cases are often an optimal solution, but lack the flexibility to be adapted to multiple applications.

ASICs are custom-designed for a particular application similar to a DSP, usually including DSP or Microcontroller (MCU) cores. This optimizes the number of transistors and clock cycles (and therefore unit cost and power consumption), at the expense of development time and cost that are generally an order of magnitude higher than those for MCUs, DSPs or FPGAs.

These technologies represent different trade-offs towards achieving the different optimizations. The choice for any particular application is an engineering compromise. In most cases, the choice depends on a complex combination of factors, and no single technology is ideal.

Various techniques have been previously considered. There are a number of existing patents relating to programmable logic processing that cover some elements of this technology; however they have not been combined to provide the advantages of this technology. Several patents have defined FGPA circuits which could relate to the concepts required to enable phased array processing. Examples of this include U.S. Pat. No. 4,870,302, which describes an interconnection method used in SRAM-based FPGA, U.S. Pat. No. 4,713,792, which describes the fabrication of macro-cells in EPROM-based Programmable Logic Devices (PLDs)), and U.S. Pat. No. 4,761,768, which describes how to build EEPROM-based PLDs. More recent patents include U.S. Pat. No. 6,301,653, U.S. Pat. No. 5,784,636, EP1634182, which among them cover routing in digital signal processing, scheduling using coupling fabric, and reconfigurable instruction word architecture.

Applications such as beamforming, cellular zone shaping and mobile source detection offer possible solutions to the problems addressed by the present application, but with either reduced flexibility of operation or increased processor operation overhead. The following list of patents provides a selection of these applications.

Beamforming: U.S. Pat. No. 6,144,711 (Spatio-temporal processing for communication), U.S. Pat. No. 5,997,479 (Phased array acoustic systems with intra-group processors), U.S. Pat. No. 6,018,317 (Cochannel signal processing system).

Zone Shaping: U.S. Pat. No. 5,889,494 (Antenna deployment sector cell shaping system and method), U.S. Pat. No. 6,104,935 (Down link beam forming architecture for heavily overlapped beam configuration).

Mobile Source Detection: U.S. Pat. No. 6,801,580 (Ordered successive interference cancellation receiver processing for multipath channels), U.S. Pat. No. 6,421,372 (Sequential-acquisition, multi-band, multi-channel, matched filter).

Embodiments of the present invention seek to bring the kind of high resolution, flexible broadband array processing required for development of next generation systems within the scope of a small footprint, low power and low cost solution.

### SUMMARY OF THE INVENTION

According to an aspect of the present invention, there is provided a data processor, comprising:

a sequence of processing stages, each processing stage comprising a plurality of processing elements, each processing element comprising an arithmetic logic unit, one or more input data buffers and one or more output data buffers, the arithmetic logic unit being operable to conduct a data processing operation on one or more values stored in an input data buffer and to store the result of the data processing operation into an output data buffer;

between each pair of processing stages in the sequence, an interconnect, for conveying data values stored in the output data buffers of the processing elements in a first one of the processing stages in the pair to the input data buffers of the processing elements in the next processing stage in the pair; and

a controller, operable to specify, in respect of each processing stage, a data processing operation to be carried out by the processing elements in that processing stage, and to specify, in respect of each interconnect, a routing from one or more of the output data buffers of one or more of the processing elements of the processing stage from which the interconnect is receiving data to one or more of the input data buffers of one or more of the processing elements of the processing stage to which the interconnect is conveying data.

The use of a pipeline of processing and data movement stages operating on blocks of data consisting of multiple sequential data items, operating under the global control of a processor, permits a high degree of configurability and control over timing. The plurality of processing units within each of the processing stages permits parallel processing of data within the pipeline. Detailed advantages of this architecture will be set out below.

The controller may be operable to specify, in respect of each interconnect, one or more bit level manipulations of the data being conveyed by the interconnect, and the interconnect may be operable to perform the bit level manipulations specified by the controller on data received by the interconnect before conveying the manipulated data to the processing stage to which the interconnect is conveying data. The bit level manipulations may be data processing operations which do not use data external to the interconnect. The bit level manipulations may comprise one or more of inversion of one or more bits of a data word, setting a first portion or a last portion of a data word to zero, and shifting one or more bits of a data word in the direction of the most significant bit or the least significant bit of the data word. In this way, certain simple manipulations of the data may be integrated with the movement of the data from one processing stage to the next, greatly improving the efficiency of processing and reducing the number of processing stages required to carry out a particular sequence of operations.

The controller may be responsive to an instruction word to specify the data processing operation for each processing stage and the routing for each interconnect, the instruction word comprising a control field for each processing stage indicating a data processing operation to be carried out by that processing stage, and a routing field for each interconnect indicating a routing operation for routing data between the processing stages connected by the interconnect. Each control field may specify a sequence of data processing operations to be carried out by the processing elements in the plane to which the control field corresponds, and each routing field may specify a sequence of routing operations to be carried out by the interconnect to which the routing field corresponds. Each routing field may specify a sequence of bit level manipulations to be carried out by the interconnect to which the routing field corresponds. In this way, a sequence of processing and interconnect stages can be flexibly configured to conduct a particular processing task. Each interconnect, each processing stage, and each processing element within each processing stage, does not require knowledge of what is going on within upstream or downstream stages—only the controller is aware and in control of the global process.

The data processor may comprise an input interface via which input data values are provided to the sequence of processing stages, and an output interface via which output data values from the plurality of processing stages are output from the sequence of processing stages, the input interface being connected to a first of the processing stages in the sequence via an interconnect, and the output interface being connected to a last of the processing stages in the sequence via an interconnect; wherein the controller specifies a routing from one or more elements of the input interface to one or more of the input data buffers of one or more of the processing elements of the first processing stage, and a routing from one or more of the output data buffers of one or more of the processing elements of the last processing stage to one or more elements of the output interface. This enables the data processor to interface with other processing circuitry within a device.

The input buffers and the output buffers may each store a plurality of words of data, the arithmetic logic units being operable to perform the data processing operation on one or more data words in an input buffer and to store the result of the data processing operation as one or more data words in the output buffer.

At least some of the processing elements may comprise a temporary storage buffer, to which the arithmetic logic unit is able to store an intermediate result of a data processing operation, and from which the arithmetic logic unit is able to obtain an intermediate result in order to carry out a next stage of a data processing operation. In this way, a single processing element may carry out multi-part data processing operations.

At least some of the processing elements may comprise a constants buffer containing data values which are not obtained from a previous processing stage and are not generated by a data processing operation of the current processing stage, the arithmetic logic unit being operable to perform the data processing operation using one or more values from the constants buffer. The constants buffer may be populated with constants received from an external source. The use of a constants buffer (which may be dynamically configurable) permits an additional level of configurability to the data processor.

Each interconnect may be operable to receive data values in parallel from a plurality of output buffers of a processing element of a source processing stage, and to provide those data values sequentially to one or more input buffers of a processing element of a target processing stage. In this way, data can be funneled to appropriate target processing elements.

Each interconnect may comprise a greater number of input data connections than output data connections, and the interconnect may be operable to time multiplex input data onto the output data connections. By providing the interconnect with more inputs than outputs, the interconnect complexity can be reduced at the expense of multiplexing outputs (which would reduce throughput). Alternatively, each interconnect may comprise a greater number of output data connections than input data connections. This might be beneficial if for example an input parameter needs to be split into two output parameters, and each new parameter sent to different destinations. It will be appreciated that each interconnect could also comprise the same number of input and output data connections.

Each interconnect may be able to convey data from any output data buffer of any processing element of a first stage to any input data buffer of any processing element of a second stage.

The timing of each processing stage may be driven by a stage-specific clock, the clock frequency of each processing stage being independently adjustable. Different ones of the processing stages may be driven at different clock frequencies. Different ones of the interconnects may be driven at different clock frequencies. One or more of the processing stages may be driven at a different clock frequency than one or more of the interconnects. Different parts of a processing stage may be driven at different clock frequencies. The benefit of the use of different clock frequencies to drive different parts of the data processor is to optimise throughput and design complexity at each stage, and potentially reduce power consumption (the perceived trade-offs must be worth the additional design complexity resulting from crossing potentially asynchronous clock boundaries).

Data may be conveyed by an interconnect to a processing stage at a first clock frequency, the conveyed data being processed by the processing stage at a second clock frequency, and the processed data being retrieved from the processing stage at a third clock frequency, wherein the first, second and third frequencies are not all the same. The first, second and third clock frequencies may be set such that the rate at which data is provided to the processing stage substantially matches the rate at which the data is processed by the processing stage, and such that the rate at which data is retrieved from the processing stage substantially matches the rate at which processed data is generated by the processing stage. In this way, data expansion or contraction resulting from a data processing operation will not cause idling in adjacent processing stages or interconnects, since the clock frequencies are set to compensate for this. As a result, power consumption can be reduced.

A clock frequency for controlling the reading of data from the output buffers of a first processing stage, transferring the data from the first processing stage to a second processing stage and writing the transferred data into the input buffers of the second processing stage may be set such that the data is transferred from the output buffers of the first processing stage to the input buffers of the second processing stage at a rate which is just sufficient to match the rate at which the data is being processed by the second processing stage. In this way, the first processing stage is performing just fast enough to support the next processing stage, seeking to minimise power consumption and maximise efficiency.

The timing of data transfers across the interconnects may be triggered globally within a common clock domain. Alternatively, the timing of data transfers may be controlled by local timing control signals which are forwarded in parallel with data.

An interconnect may be operable to begin transferring data from a first processing stage to a second processing stage before the first processing stage has completed the data processing operation. This is possible where the order in which data is generated by the first processing stage is known, such that “complete” data can be retrieved while subsequent data is being generated. This is commonly the case with the present architecture, since overall control of sequencing and timing is conducted centrally by the controller.

A second processing stage may be operable to begin a data processing operation on data received via an interconnect from a first processing stage before the transfer of data from the first processing stage to the second processing stage has completed. Again, this is possible where the order in which data is transferred by the interconnect is known, permitting data to be operated on as soon as it is received by the second processing stage. This is commonly the case with the present architecture, since overall control of sequencing and timing is conducted centrally by the controller.

The controller may be operable to route a data value stored in an output buffer of a processing element of a first processing stage to an input buffer of a plurality of processing elements of a second processing stage. In this way, data generated by one processing element can be operated on in parallel by multiple processing elements of the subsequent stage.

The controller may be selectably controllable by an internal or external source.

The controller may be responsive to exception conditions generated at one or more of the processing stages and/or interconnects to control the handling of the exception. This enables the controller to step in and attempt to resolve an issue should an unexpected event occur during processing of the data.

According to another aspect of the present invention, there is provided a method of processing data through a sequence of processing stages, each processing stage comprising a plurality of processing elements, each processing element comprising an arithmetic logic unit, one or more input data buffers and one or more output data buffers, the method comprising the steps of:

at an arithmetic logic unit in a first one of a pair of processing stages, conducting a data processing operation on one or more values stored in an input data buffer and to store the result of the data processing operation into an output data buffer;

using an interconnect provided between each pair of processing stages in the sequence, conveying data values stored in the output data buffers of the processing element in the first one of the processing stages in the pair to the input data buffers of a processing element in the next processing stage in the pair;

specifying, in respect of each processing stage, a data processing operation to be carried out by the processing elements in that processing stage; and

specifying, in respect of each interconnect, a routing from one or more of the output data buffers of one or more of the processing elements of the processing stage from which the interconnect is receiving data to one or more of the input data buffers of one or more of the processing elements of the processing stage to which the interconnect is conveying data.

A microprocessor architecture comprising the data processor described above, and a computer program which when executed on a data processing apparatus causes the data processing apparatus to perform the method described above, are also envisaged as aspects of the present invention.

In general terms, the above aspects and embodiments of the architecture contain a number of new and innovative elements:
The relationship between Processing Elements and the Data Movement structures (interconnects) between planes.
The use of a VLIW (Very Long Instruction Word) to control the functionality and sequencing of the Processing and associated Data Movement structures in order to create efficient pipeline processing processes.
The potential use of clock phase offsets, clock dithering and Spread Spectrum Clocking in order to control and reduce dynamic current loads, and improve the emitted RFI performance of the system or device.
The use of simple state driven processing elements combined with a mode controlled interconnect fabric or fabrics enables the efficient implementation of a specific class of processing problems.

The invention has a number of advantages over known processing architectures:
Power consumption is reduced.
The system is cheaper to implement than a dedicated ASIC but more powerful and also cheaper to implement than other FPGA based solutions.
The system is more configurable than an ASIC—supporting more than one application while still being ‘application specific’ through dynamic reconfiguration, while providing greater capability than other FPGA based solutions.
The inherent synchronicity of the system means that system wide clocking is not necessary, resulting in lower RF emissions and applicability in applications where a low RF signature is beneficial (e.g. military applications and radio telescopes).
Optimised data word sizes can be used in the data pipeline to control the growth of the data generated, and hence manage power consumption and system complexity

Expanding on these benefits, the following observations are made:

Reduced Power Consumption:
Power use may be reduced as actions are performed as burst activities and the ALUs are not required to run at all times.
The clock tree is simplified compared to other processors that use a large clock tree (and more power) through use of a multi-cycling interconnect as long as order is preserved. This clock system, which uses regionalised clocking regimes and an overall timing reference rather than synchronised clocking on all events allows power saving.
The inherent coherence of the data means that synchronisation management isn't needed and this removes some overhead of the process both in terms of power and time.

Configurability:
This device could be considered a new class of processing device, different from a Graphics Processing Unit (GPU)/FPGA, in which the chip is driven by a microcode vector table.
As shown in FIG. 1, algorithm generation can use standard Simulink/MATLAB software 39, which is then converted via a processor specific toolbox/compiler 40 and then used by the architecture 41 (which utilises processors, tables (which can be read by the processors), and an instruction which may both populate the tables and control the processors).
Using this high level approach to configuring the processor won't compromise performance or implementation of algorithm (a normal issue with this type of approach).

Increased Flexibility:
Data may be transferred and preformatted (by the interconnect) in one move; this enables large matrix real-time processing to be more efficiently performed. This means that techniques such as digital signal processing and beamforming can be improved through the use of this architecture.
This also opens up potential mechanisms for asynchronous processing, as non-reliance on time removes many of the issue with maintaining clocks.
The architecture may also be able to use multi-cycle logic structures and self-timing systems for further flexibility.

Performance optimization:
By optimising the data word size in the pipeline, control of data growth can be implemented, with compromises on accuracy by reducing number of calculations/iterations performed.
Simplifying processing elements by removing the extra routing per element and placing the data routing into the Data Movement (i.e. interconnect) plane means that the overhead of the logic being in the interconnection is less than being in each processor.
Use of interconnect-fabric for data linkage is better than a cross-connect system, as it requires less buffering.

Reduced RF Signature:
For radio applications, this process offers reduced RF signature. This can be done by introducing phase uncertainty, spread spectrum techniques, using randomising diode(s)/clock dithering.

### DETAILED DESCRIPTION

The invention will now be described by way of example with reference to the following Figures in which:

FIG. 1 schematically illustrates an example processor algorithm generation method utilising Simulink/MATLAB;

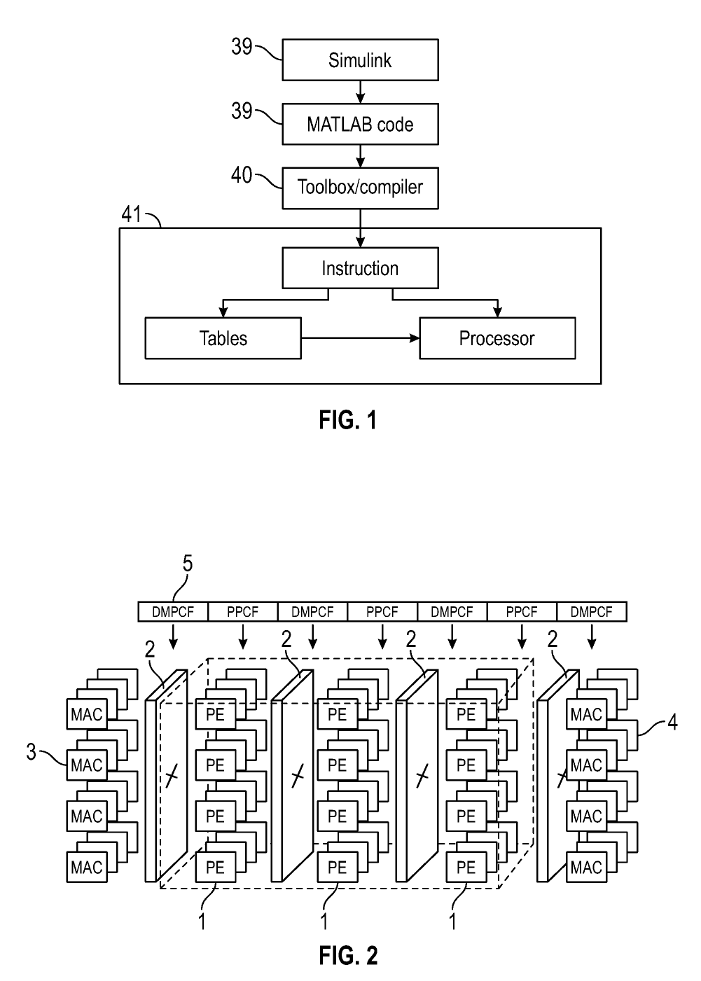

FIG. 2 schematically illustrates a processor architecture;

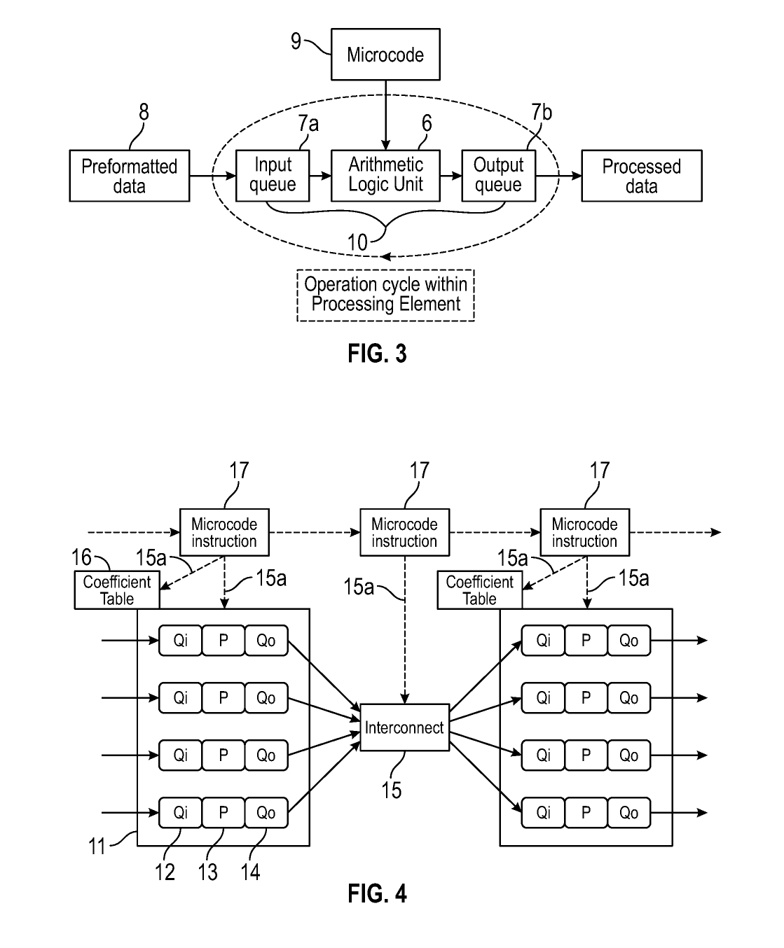

FIG. 3 schematically illustrates a single processor element operation cycle;

FIG. 4 schematically illustrates processing planes comprising multiple processing elements;

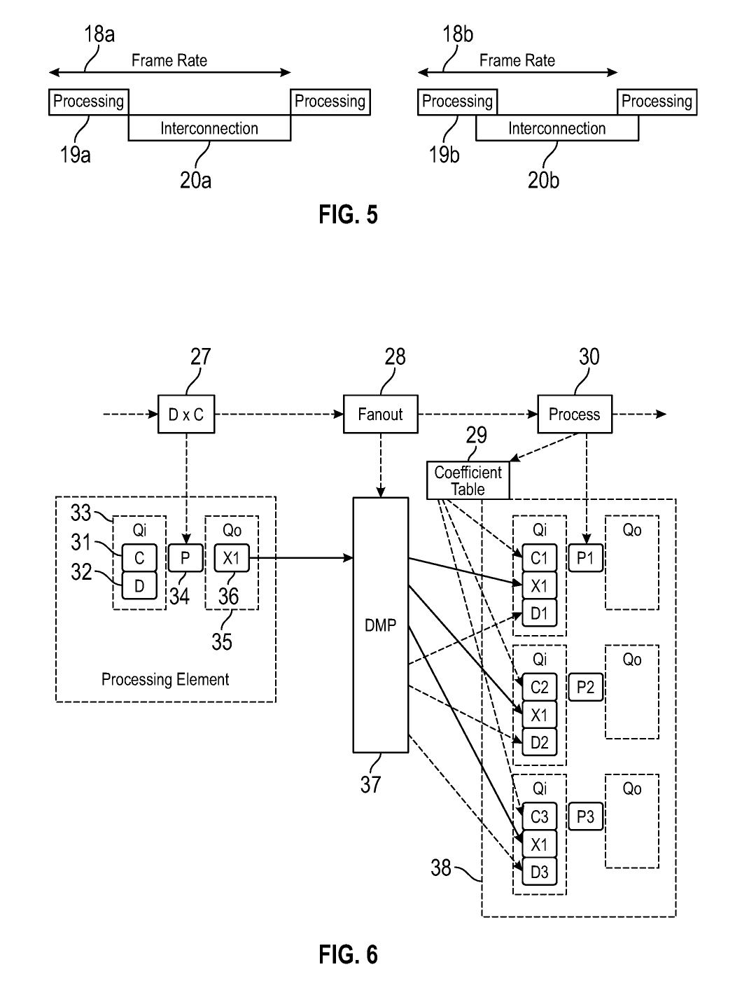

FIG. 5 schematically illustrates a plane process and interconnection frame rate compositions;

FIG. 6 schematically illustrates an example fan out operation;

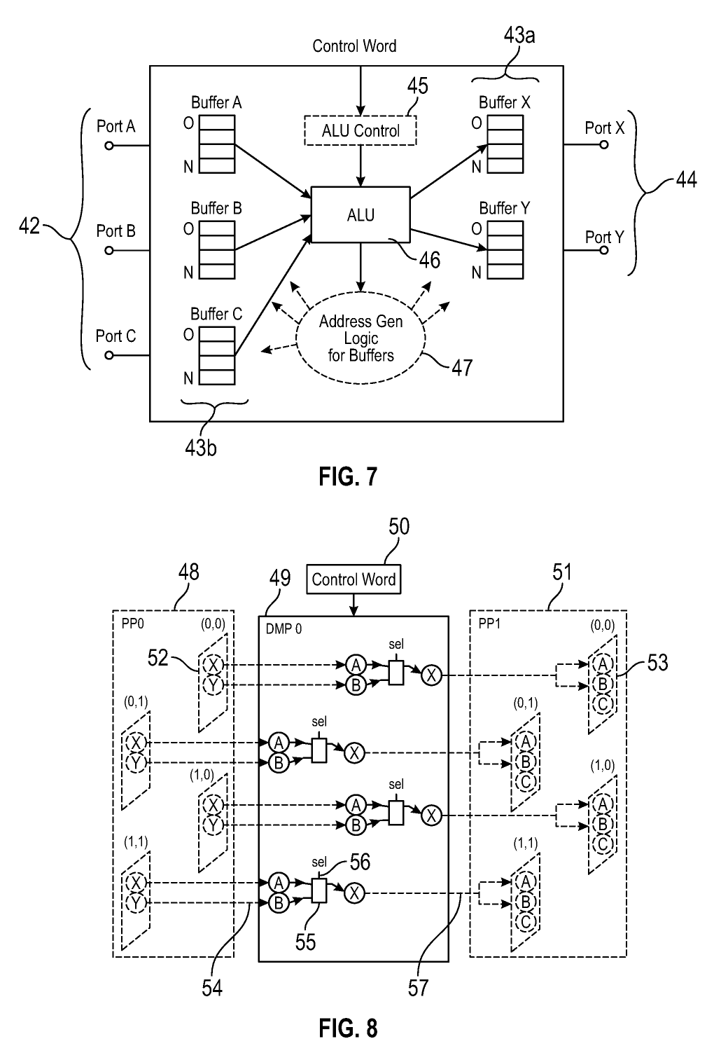

FIG. 7 schematically illustrates an example processing element;

FIG. 8 schematically illustrates an example data movement plane;

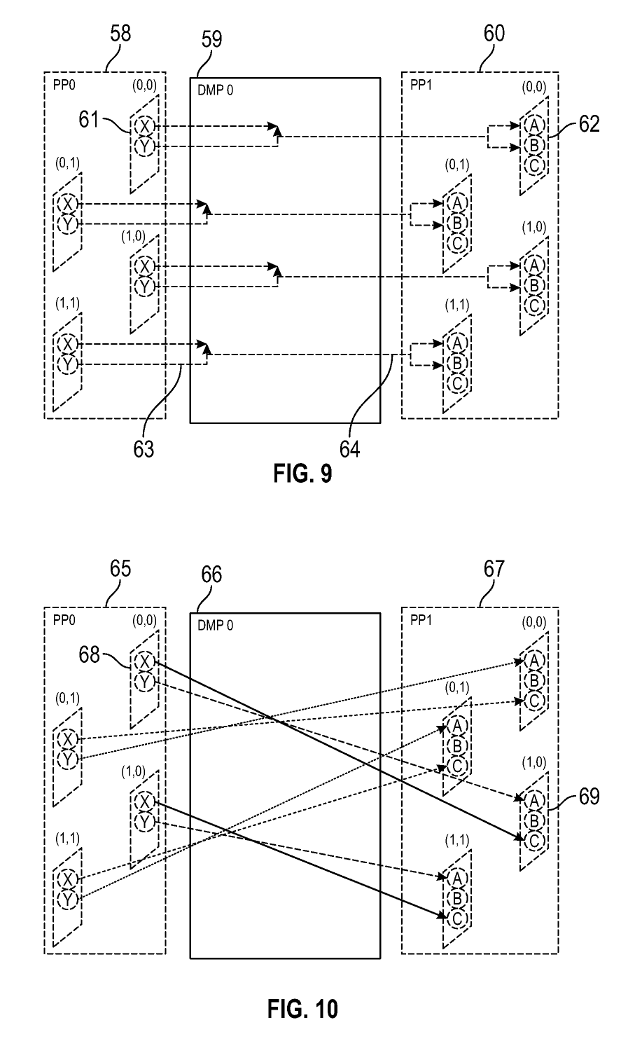

FIG. 9 schematically illustrates a symbolic data movement plane (simple);

FIG. 10 schematically illustrates a symbolic data movement plane (complex);

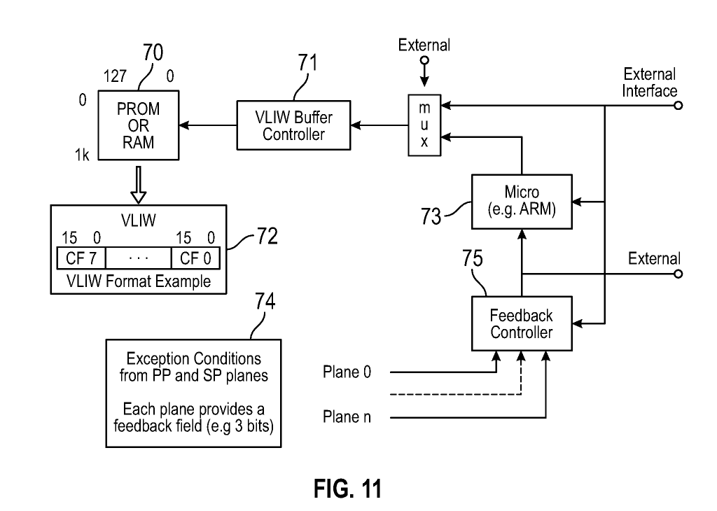

FIG. 11 schematically illustrates a VLIW control module;

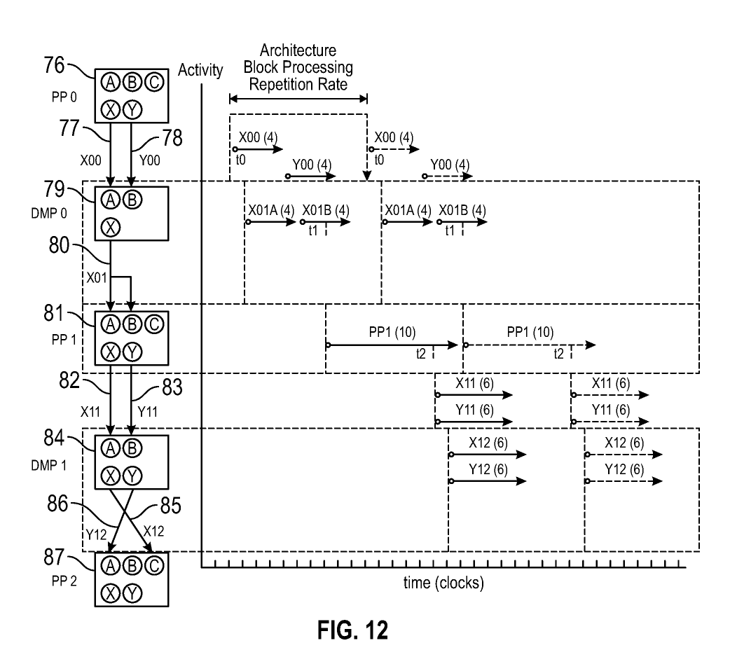

FIG. 12 schematically illustrates the data processing capabilities of the processing stages;

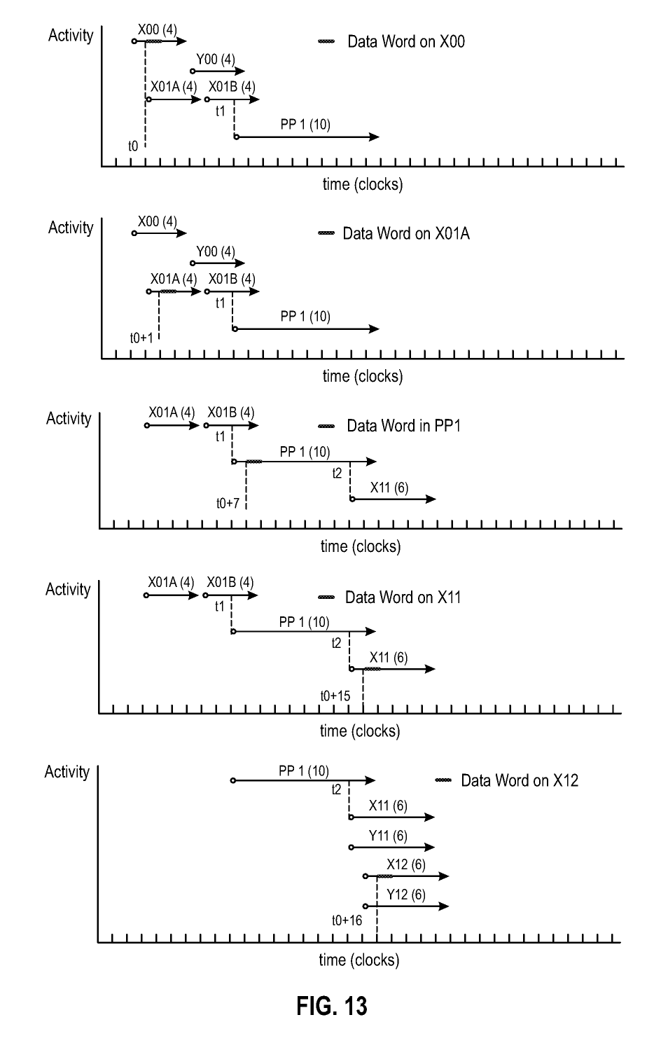

FIG. 13 schematically illustrates an example processing data word tracking;

FIG. 14 schematically illustrates time domains across processing plane boundaries;

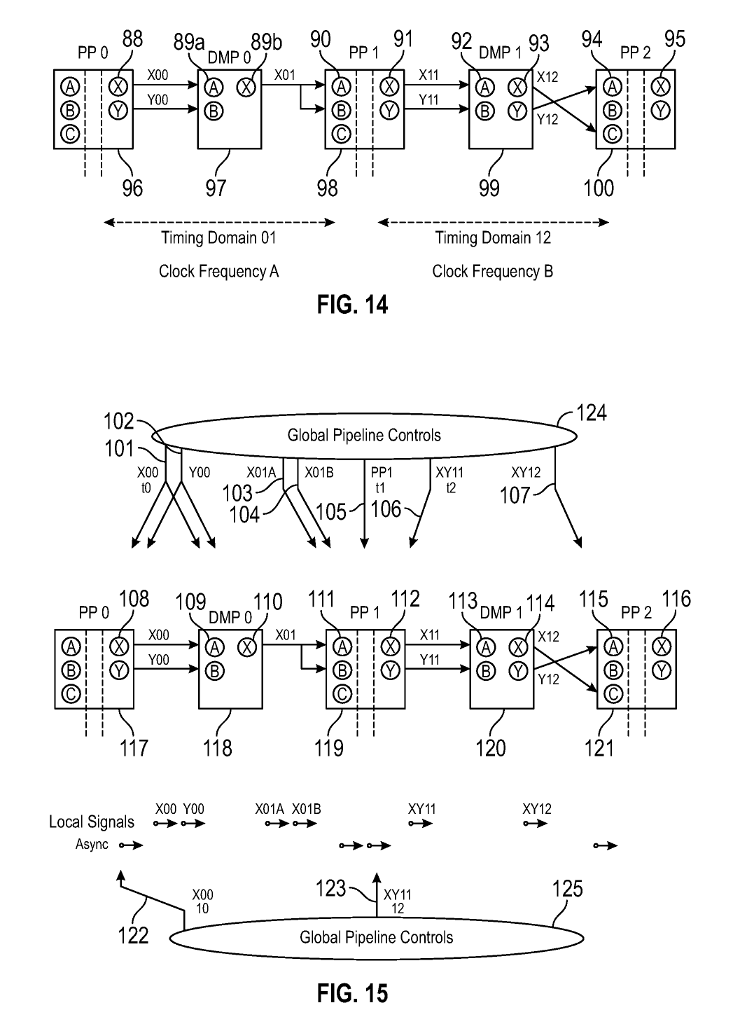

FIG. 15 schematically illustrates inter-plane data transfers;

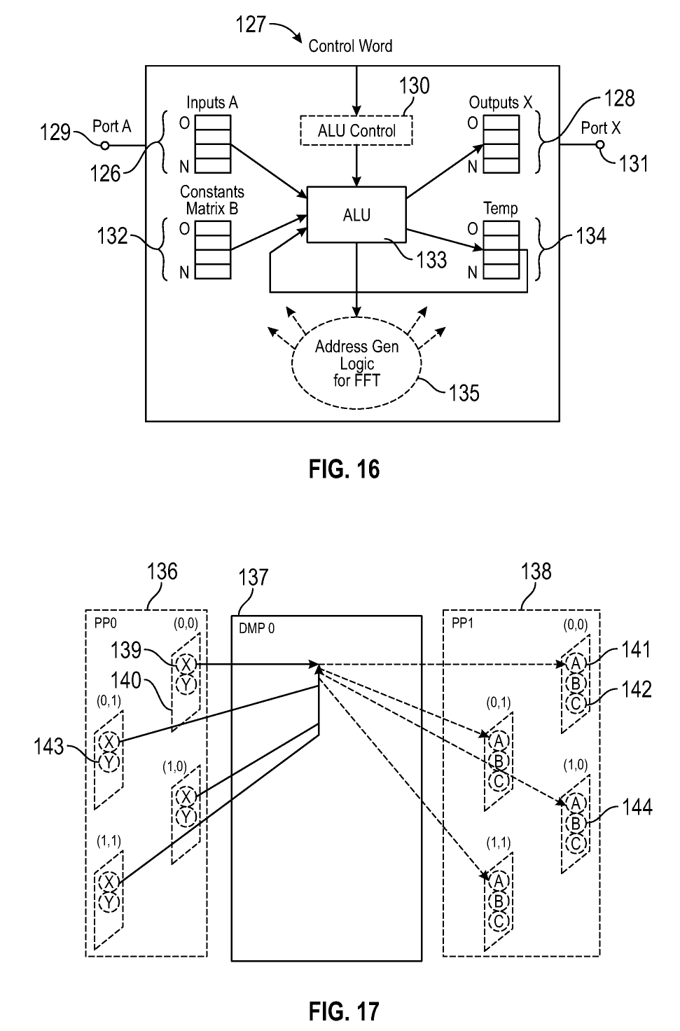

FIG. 16 schematically illustrates an FFT processing element;

FIG. 17 schematically illustrates an inter-stream data movement plane;

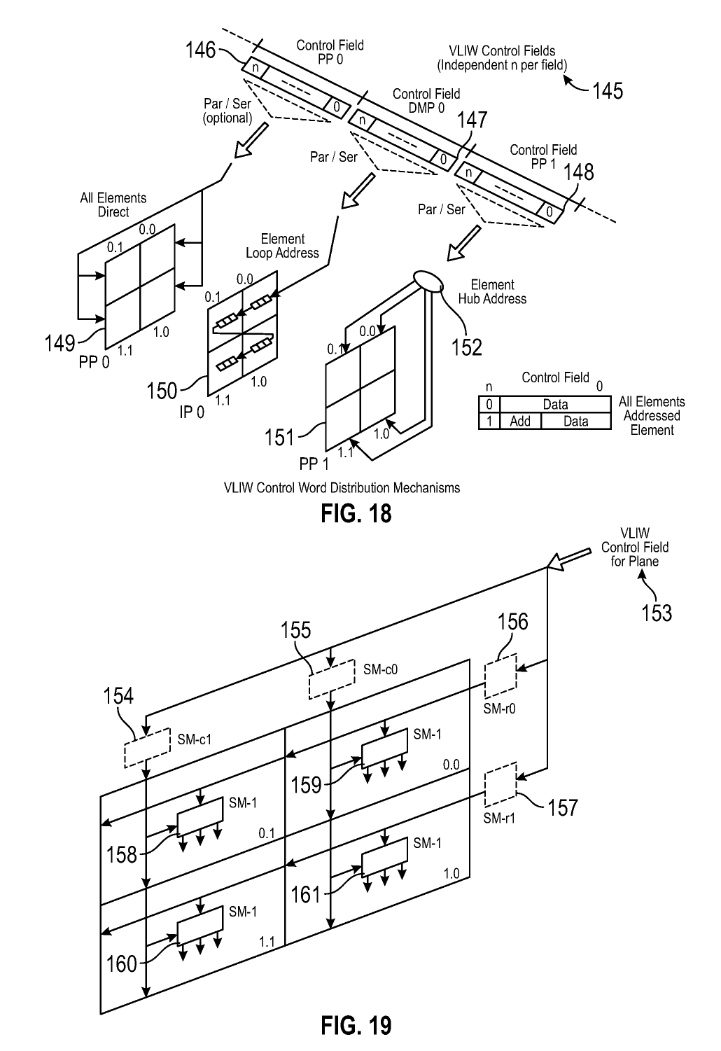

FIG. 18 schematically illustrates an example VLIW control word distribution mechanisms;

FIG. 19 schematically illustrates an example VLIW control field distribution for a plane; and

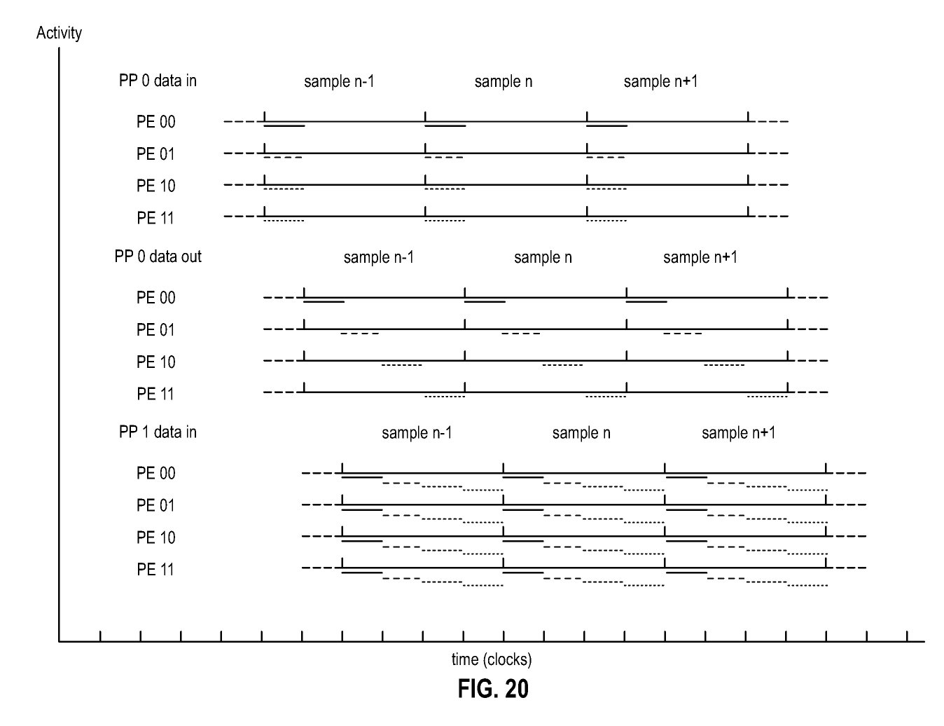

FIG. 20 schematically illustrates a sequence of data transfers for beamforming.

Referring to FIG. 2, a Synchronous Phased Array Compute Engine (SPACE) based data processor is schematically illustrated. The data processor described herein is a new and advantageous combination of processing modules, data movement, and interface building blocks. These concepts are combined in a unique architecture which provides an optimal combination of efficient data movement, flexibility and optimised processing. The device can be considered as a pipeline of SIMD (Single Instruction Multiple Data) processing ‘planes’ connected together via a deterministic programmable connectivity network. The pipeline is programmed in the time dimension via a VLIW (Very Long Instruction Word) instruction vector which configures data movement and pipeline operations within a single device pipeline instruction. In particular, as can be seen in FIG. 2, multiple SIMD processing Elements (PEs) 1 are configured in n×n processing planes. It will therefore be appreciated that each processing plane comprises a plurality of processing elements 1 which can operate in parallel on (generally) different data. Each processing element 1 is able to process one or more words of data. They are interconnected by Data Movement Plane (DMP) 2 components, or interconnects, the collection of which form a Dynamic Data Movement Capability (DDMC). At the start and end of the pipeline respectively are MAC (Media Access Control) elements 3, 4 which provide an interface with the rest of the system. Data generally propagates through the pipeline from left to right (although some embodiments may provide for reverse data flow) through the processing stages. More specifically, data is provided to the data processor from elsewhere in a data processing system via the set of input MAC elements 3. The first data movement plane retrieves the provided data from the MAC elements 3 and passes that data to the first of the processing planes, typically as data words. The first data movement plane may manipulate bits of the data words in bit level manipulations before passing the bit-manipulated data to the first processing plane. The first processing plane then executes a processing operation on the data word(s). Once the processing operation is completed at the first processing plane, the second data movement plane retrieves the processed data from the first processing plane and passes that data to the second of the processing planes. The second data movement plane may manipulate bits of the data words in bit level manipulations before passing the bit-manipulated data to the second processing plane. The second processing plane then executes a processing operation on the data words. Once the processing operation is completed at the second processing plane, the third data movement plane retrieves the provided data from the second processing plane and passes that data to the third of the processing planes. The third data movement plane may manipulate bits of the data words in bit level manipulations before passing the bit-manipulated data to the third processing plane. The third processing plane then executes a processing operation on the data words. Once the processing operation is completed at the third processing plane, the fourth data movement plane retrieves the provided data from the third processing plane and passes that data to the output MAC elements 4, from which they can be retrieved and used externally of the data processor of FIG. 2. The fourth data movement plane may manipulate bits of the data words in bit level manipulations before passing the bit-manipulated data to the output MAC elements 4. A VLIW 5 contains routing fields (DMP CF), which determine how the data will be transferred between the PEs, interspersed with control fields (PP CF) which carry operating code which determines the operations to be executed by the PEs. More particularly, the VLIW 5 comprises a control field for each processing plane, and a routing field for each data movement plane/interconnect. As will be discussed further below, each control field comprises a set of data processing operations to be carried out by the processing plane to which the control field corresponds, while each routing field comprises a set of routing operations to be carried out by the interconnect to which the control field corresponds. While the data processor of FIG. 2 is shown to comprise 3 processing planes/stages, it will be appreciated that different numbers of processing planes/stages may be provided, depending on the application. Similarly, while the data processor of FIG. 2 shows 16 input MAC elements 3, 16 output MAC elements 4 and 16 processing elements in each processing stage, a number other than 16 can be provided, depending on application. Further, each processing stage need not necessarily comprise the same number of processing elements (although often they will do)—in some cases different numbers of processing elements may be provided in each or certain processing planes/stages.

This core architecture provides for a planar VLIW processing device which situates interconnection (i.e. switching and routing) of calculation actions in an independent routing plane rather than as part of the processing component. Referring to FIG. 3, which schematically illustrates a single processing element operation cycle, the system can be seen to run at a processing element 10 level, with data entering an input queue 7a having been pre-formatted 8 by bit level manipulations carried out by the upstream interconnect which is providing the data to the processing element 10. The bit level manipulations may include any modification to bits of data words without utilising external data, including bit reversal, optimising word sizes (e.g. by transforming a 24 bit word into a 12 bit word or vice versa), truncating a data word by setting the least significant bits to zero, move and/or reverse operations etc. Generally, these modifications are relatively fast modifications carried out on a bit level (rather than combining a word of data with another word of data), which can be carried out at the same time as moving data between processing planes (where more computationally expensive data processing operations can be conducted), thereby improving the efficiency of the data processor. Items in the queue 7a are then selected for processing by an ALU (arithmetic logic unit) 6 which is controlled by injected microcode 9 from the VLIW field corresponding to the processing plane which the processing element 10 belongs to. Once processing is complete the data is passed as processed data to an output queue 7b from which it can be retrieved by the downstream interconnect. Generally, all (active) processing elements 10 within a given processing plane will conduct the same processing operation, but in relation to different data. In other words, all processing elements 10 within a given processing plane are controlled simultaneously by the same VLIW field. However, only processing elements 10 which have data to process need carry out the processing operation, with all other processing elements 10 being in an inactive state to save power. It will be appreciated that some processes which may be handled by the data processor may require a different amount of data to be handled in each processing plane, for example due to data growth. For example, if the amount of data is doubled for each plane, then the first processing stage may only operate on four words of data simultaneously (requiring only four processing elements 10 to be operational, the remaining twelve being left inactive to save power), the second processing stage may operate on eight words of data simultaneously (requiring only eight processing elements 10 to be operational, the remaining eight being left inactive to save power), while the third processing stage may operate on sixteen data words simultaneously, requiring all sixteen processing elements 10 to be operational. It will be appreciated in this case that power usage is thereby optimised by each processing stage utilising only the processing elements it needs to, with the remaining processing elements being left in an inactive or low power state.

Referring to FIG. 4, each Processing Plane (PP) 11 can be seen to comprise multiple processor elements (P) 13 which each use their own coefficient table 16. A data path for passing microcode instructions 17 uses an interface 15a with a simple instruction loading mechanism. An input data queue (Qi) 12 and an output data queue (Qo) 14 are treated as distributed data memory, with no chip memory interface being required. In other words, each processing plane and/or element is provided with memory (locally) to support input/output queues. In this way, memory is distributed around the chip (which carries the data processing), resulting in power saving advantages due to the fact that it is not necessary for each processing element to retrieve data from a centralised and remote memory location. It can be seen from FIG. 4 that the output queues 14 of the processing elements 13 are connected to the interconnect (i.e. the Data Movement Plane) 15, which is able to route the data from the output queues 14 to the input queues of the next processing plane. It can also be seen that there is a microcode instruction (obtained from the VLIW) for each processing plane 11, as well as for the interconnect 15. Microcode instructions can be used not only to specify the processing operation to be carried out at a processing plane, but also to load coefficient values into the coefficient table 16, thereby providing a further degree of configurability.

Referring to FIG. 5, frame repetition rates (i.e. the sum of a processing plane and an interconnect plane data transfer interval) are schematically illustrated. As can be seen from the left hand part of FIG. 5, a frame rate period 18a of a processing mechanism as described above will be composed as two distinct parts—processing 19a and interconnection 20a. The processing part 19a is the amount of time required for a processing element (or all processing elements in a processing stage) to conduct a current data processing operation on the data held in its/their input queue(s). The interconnection part 20a is the amount of time required for the interconnect 15 to retrieve data from the output queue of the process element, preformat/manipulate it on a bit level (if required), route it towards the appropriate processing element in the next processing stage, and store it into the input queue corresponding to that target processing element. In the left hand representation of FIG. 5, there is no overlap between the processing 19a and interconnection 20a parts. In other words, in this case the movement of data from one processing plane to the next by the interconnect (interconnection part 20a) does not occur in this case until the processing 19a part is complete. It will be understood that the shorter the frame rate period, the faster the frame rate. In the right hand representation of FIG. 5, it can be seen that some overlap may occur between processing 19b and interconnection 20b parts in circumstances where the operation has been defined by the instruction word in a manner in which the interconnect is able to start retrieving processed data from the processing plane before processing by that plane has been completed. In such cases the frame rate period 18b is instead measured from the beginning of the processing part 19b to the beginning of the following processing part. As a result, the frame rate is faster in the right hand representation than in the left hand representation. As an example, if there are 8 words present in an output buffer, it is usually simplest to transfer these in address order (e.g. 0 to 7). If the output buffer is filled in incrementing address order, address 0 can be transferred just after the data becomes valid (e.g. as address 1 data is being generated), as in 20b. If output data is generated in a more complicated order (e.g. addresses 0, 4, 1, 5, 2, 6, 3, 7), it may be simpler to wait until the output buffer is full (or at least just over half full in this example), and then still transfer the contents in incrementing address order. An FFT algorithm is an example of where data is not always generated in an “easy to transfer” address sequence.

### Example Use

An example is a cross multiplication operation, as schematically illustrated in FIG. 6. This type of operation will create additional data to be transferred via the DMP and hence in the ongoing pipeline. In this example, coefficients (C) 31 and data (D) 32 present in an input queue (or input buffer) 33 in the first plane are processed according to the control field operation 27 (in this case specifying the multiplication D×C) by an ALU 34 in the processing element, and the output x₁ of this operation 36 is held in the output queue 35 before proceeding to the DMP/interconnect 37. An operation 28 supplied to the DMP sets a fan out of the output x₁ to all processing elements in the next plane 38 which then performs a process 30 assigned to each element in the plane 38 using not only the data x₁, but also coefficients C₁, C₂, C₃ obtained from that plane's coefficient table 29, and other data D₁, D₂, D₃ generated from different processing elements of the first processing plane and previously (or simultaneously) transferred to the processing plane 38. Management of this data and choosing what to push to a PP and where to push it are important considerations in operating the system. It will be appreciated from this example that each processing plane is capable of carrying out data processing operations using not only data received via the interconnect from a previous processing plane, but also predetermined coefficient data locally stored in a table. In some applications the coefficient data may be entirely static. In other cases the coefficient data may be regularly or occasionally updated. Generally though the coefficient data will remain unchanged over a plurality of processing cycles, in contrast with the data propagating through the processing stages which is much more changeable and dynamic. It can also be seen from FIG. 6 that the DMP is capable not only of routing a data word from a single selected output queue of one processing plane to a single selected input queue of the next processing plane, but also of routing the same data word (x₁ in this case) from a single selected output queue of one processing plane to multiple input queues of the next processing plane. The routing is controlled by the routing field of the VLIW, which in this case specifies a fan out instruction, which might indicate a source processing element (of the source processing plane) and a set of plural target processing elements (of the destination processing plane).

In this example (and that of similar cases) the volume of data generated at some intermediate processing stages of the architecture will increase relative to the size of the input data (e.g. a potential square law relationship), causing the frame processing rate to drop relative to the rate required to cope with just the input data. The use of multiple clock domains within the architecture can improve the management of this data. The key fact here is that this change in data handling is only done when needed where data can fan in/out as required, a strategy which can only be done with time-domain data processing rate changes.

Each stage in the pipeline is capable of managing growth in a different way according to the VLIW. This allows each part of an algorithm to be handled in a different way as necessary. In doing so only the required data has to be moved at a particular rate, which means that power efficiency is improved. This is an adaptive system which works by updating instructions and/or coefficient tables for the PPs at a required rate for a given application. There is potential for the architecture to be used in conjunction with a microcontroller to manage coefficients from an external source directed via (e.g.) Ethernet. This could have use in radio/telecommunications traffic management to create and manage virtual cells. Work on bandwidth management in 5G would also be relevant. Other applications include use in a passive-mm security scanner, which would involve a raster scan of a zone, injecting coefficients, breaking zone into small blocks to focus receiver, and measurement/reconfiguration by dynamic updates. This device could also be generically useful where parallel data streams are used, examples being cryptography, parallel data processing or bitcoin mining.

### Architecture Elements

There are multiple ways to implement a PP and DMP pair, and several strategies will be detailed below. A PP consists of an array of PEs, and a DMP behaves as an interconnect function to transfer data between PPs.

Processing Plane

Referring again to FIG. 4, a PP comprises an array (e.g. a 2×2 array) of PEs. Each PE within a PP may be identified using a pair of subscript numbers, as for elements in a simple mathematical matrix.

Referring to FIG. 7, an example processing element is shown which in this case contains 3 input ports (A, B, C) 42 and 2 output ports (X, Y) 44. It will be appreciated that this is just one example implementation, and other implementations may use different numbers of input ports (for example 1, 2 or 4 ports), and different numbers of output ports (for example 1 or 3 ports). More generally, each PE may contain multiple unidirectional ingress 42 and egress 44 ports together with per port (buffer/queue) storage 43a, 43b, an ALU capability 46, and internal micro-coded units to control buffer addressing 47 (address generation for buffers) and ALU operations 45 (ALU control). Typically, each processing element within a given processing plane will be substantially the same (e.g. same number of input/output ports).

Processing Element

An individual port buffer will usually be implemented as a dual port buffer for performance reasons (although a single port buffer can also be specified), and contain any number of address locations (e.g. 128 words, numbered [127:0]) of any width (e.g. 16 bits, numbered [15:0]). For convenience, the diagram shows all buffers to be the same size (N words). More complex buffers may also be implemented as necessary. Buffer addresses may optionally be generated internally to the PE by an address sequence generation unit, or may instead be supplied to the PE from an external address generation unit, as dictated by the Processing Plane Control Word in the VLIW. The ALU operations can be similarly controlled using the Control word. The PE will perform data operations by reading data from the ingress buffers, performing the specified ALU operation (from the VLIW), and writing the modified data to the egress buffer(s). Optionally, each PP may contain a pair of asynchronous clock domain crossing boundaries, to separate the ingress and egress data domains from the internal data processing domain. In other words, data may conveyed by an interconnect to the ingress buffers 43b at a first clock frequency, the conveyed data may be processed by the ALU and stored to the egress buffers 43a at a second clock frequency, and the processed data may be retrieved from the egress buffers 43a at a third clock frequency, wherein the first, second and third frequencies are not all the same. So, for example the first, second and third clock frequencies may be set such that the rate at which data is provided to the ingress buffers 43b substantially matches the rate at which the data is processed by the ALU 46, and such that the rate at which data is retrieved from the egress buffers 43a substantially matches the rate at which processed data is generated by the ALU 46. It should be understood here that the rate at which ingress data is processed by the ALU may be different from the rate at which egress data is generated by the ALU, since the data processing operation may result in an amount of egress data which is less than or greater than the amount of ingress data. As a result, the first and third clock frequencies may be different.

As a processing example, buffer X may be updated to contain results obtained from the ingress data in buffers A and C (e.g. X[n]=A[n]+C[n]), and similarly buffer Y might contain Y[n]=B[n]−C[n], for all values of n (i.e. [127:0]). In this case, each of the N data words in the egress buffers X, Y are obtained from an arithmetic combination of corresponding ones of the data words in the ingress buffers A, B, C. Referring back to the frame rate composition of FIG. 5, it will be understood from FIG. 7 that it may be possible for the interconnect downstream of the egress buffers X, Y to start retrieving data words from the buffers (for particular, e.g. lower, values of n) at the same time as those buffers are being updated with new data (for particular, e.g. higher, values of n). This results in a reduction in the frame rate period (and thus an increase in frame rate).

Data Movement Plane

Referring to FIG. 8, an example data movement plane is schematically illustrated. As can be seen in FIG. 8, a DMP 49 connects adjacent PPs 48, 51, and is used to transfer data between the PEs in each PP under the control of the VLIW 50. The simple example DMP of FIG. 8 illustrates the type of connectivity that can be achieved within the architecture. In FIG. 8, egress buffers X, Y 52 of the processing elements of a first processing plane (PP0) are represented for each of four processing element (0,0), (0,1), (1,0), (1,1). The DMP (DMP0) 49 connects PE outputs X and Y 52 from the ingress PP 48 (i.e. PP0) to PE inputs A and B 53 in egress PP 51 (i.e. PP1). FIG. 8 shows the connectivity between the PPs via the DMP 49, and also indicates the following details concerning the DMP data linkage strategy. In particular, two data connections (e.g. busses or serial links) 54 from each PE exist between PP0 and DMP0, while only a single data connection 57 exists between DMP0 and PP1. This indicates that data sets X and Y must be transferred sequentially (rather than in parallel) between the PPs, and the logical functionality within the DMP is illustrated as a simple multiplexor 55 for each PE. The multiplexor 55 provides data words from egress buffer X of PP0 to ingress buffer A of PP1, and data words from egress buffer Y of PP0 to ingress buffer B of PP1. A select signal 56 (sel) for the multiplexors is operated (in the time domain) as specified by the Data Movement Plane Control Word 50 in order to control the multiplexing of data from the ingress buffer A and the ingress buffer B onto the connection 57 so that it can be appropriately stored into the ingress buffers A and B of the second processing plane (PP1). Optionally, a state machine sequencer may exist between the Control Word and the multiplexor controls to sequentially step through the set of routing operations defined in the routing field corresponding to DMP0. In this way, the state machine sequencer keeps track of which routing operation is being conducted in each clock cycle, and then steps into the next routing operation in the set for the next clock cycle. In the present example, data is transferred from a PE 52 in the ingress PP 48 (e.g. PE 0,0) to a PE 53 in the same relative position (0, 0) in the egress PP 51. Each DMP 55 egress data bus is shown as being connected to two ingress ports (i.e. A and B) in each PE in PP 1, enabling data from either egress port X or Y to be transferred to ingress ports A or B, or to both ports A and B simultaneously. No data storage exists within the PP, apart from simple pipeline stage registers.

The connectivity between PPs can become quite complicated, so a more symbolic representation of a DMP is schematically illustrated in FIG. 9, and will be used to illustrate some of the interconnect possibilities. This represents the same logical situation as described above in FIG. 8, but without showing the internal DMP logic, which is now implicit. In FIG. 9, it can be seen that there are twice as many data connections 63 going into the DMP 59 as leaving it 64, so by implication DMP ingress data will be time multiplexed onto the egress data connection (unless specified otherwise). Referring to FIG. 10, again schematically illustrating a symbolic data movement plane, a more complicated DMP connectivity diagram is provided, in which the number of ingress data connections is the same as the number of egress data connections. As a result, data transfers (e.g. egress port X in PP0 to ingress port C in PP1, and egress port Y in PP0 to ingress port A in PP1) can take place simultaneously. Moreover, PE connections are rotated between PE elements 68, 69 in the different PPs 65, 67 rather than being routed between two processing elements at the same position (e.g. 0, 0) in different planes, implying multiple levels of multiplexing within the DMP 66. Again, the routing between processing planes, in terms of source port and processing element selection, and destination port and processing element, is specified in the routing control field in the VLIW. It will be appreciated that this provides for a highly flexible routing scheme between processing planes.

VLIW Control Module

The VLIW control module (CM) supplies VLIW control words to the SIMD planes, as shown schematically in FIG. 11. The CM provides the following main operational capabilities: —
An external signal to select the control source for the CM using a multiplexer, between an internal processor 73 or an external source (via an external interface).
An optional simple internal processor 73 (e.g. an ARM microprocessor), for generating control instructions.
A VLIW buffer 70 to supply the required VLIWs 72 to the SPACE array. The buffer 70 may comprise any combination of PROM and RAM, to allow VLIW updates to be supplied as necessary. The buffer size can be specified for a particular application. An example buffer size with 1 k entries of 128 bit words is shown. System logic is able to cycle through the VLIW entries, executing them in turn.
A VLIW buffer controller 71, to generate buffer addresses. The buffer addresses can jump to an exception sequence if the feedback controller detects that something is wrong, or be used to initialise the buffer if the buffer consists of RAM rather than PROM (etc.).
The VLIW format can be specified. An example VLIW format 72 containing 8 control fields (CF7:CF0) of 16 bits each is shown, although the field sizes can independently vary. Each control field relates to a specific processing plane or interconnect.
The functionality of a control field can be specified for an application by defining an application-specific set of data processing operations and routing operations.
Exception condition signals 74 exist within each plane in the SPACE array, to enable any exception conditions within the pipeline to be detected. These exception condition signals from the processing planes and data movement planes may take the form of a 3 bit (for example) feedback field. These signals are fed back by a feedback controller 75 to the CM, to enable appropriate handling of the situation. The CM can use the exception information to control the SIMD array via the VLIW buffer controller 71. A simple example of this is where a processing plane detects an internal error. In this case, the feedback condition could alert the CM, which may for example try to reset the processing plane to an initial state in an attempt to fix the problem, by providing an appropriate control field to the processing plane.
The CM may also be responsible for initializing the architecture.

Data Processing and Transfer Strategy

Data transfers through the various planes within the architecture are controlled using synchronising signals, as explained in the following sections. Each plane in the architecture will initiate a block of data transfers when triggered to do so, and each plane (i.e. PP or DMP) will also independently generate all internal control sequences required to perform the data transfer (as specified by the VLIW control inputs). A block may be a group of words, for example a group of 1024 data samples for a 1 k FFT operation. An example architecture consisting of a pipeline of the types of planes described so far in this document is now described.

In particular, referring to FIG. 12, which schematically illustrates the data processing capabilities of the data processor, two consecutive example data transfers from PP0 are shown and described in detail using small data blocks for convenience. The planes are connected as shown. The functional timing diagram illustrates how data (e.g. a block of 4 data words on X00 77, where the bus name is derived from the numbers of the planes connected at either end of the bus) can be transferred through the various planes as the data blocks are processed. The diagram also illustrates potential throughput dependencies between the various planes, and shows how an overall architectural data processing repetition rate (i.e. the rate at which planes need to process data blocks) can be determined.

The following activity occurs at each interface on the various planes;
Assume PP0 76 is ready to forward the results of its calculations on a data block. Four words are to be transferred from port X 77, and four words are to be transferred from port Y 78.
PP0 76 is unaware of any downstream architectural connections (i.e. that port X is ultimately to be connected to port A on PP 1 81), and simply forwards the data from the output buffer on port X 77 in the order specified by its own internal address generator, when triggered to do so, as specified by the VLIW control inputs. Similarly, port A on PP1 81 is simply set up to receive a data transfer (when triggered), with the order of the ingress buffer addresses being independently generated by its internal address generator.
When triggered (i.e. at time t0), PP0 76 outputs 4 words on bus X00 77 as shown, and these words will be forwarded by DMP0 79 (see X01A on the timing diagram) on bus X01 80 within a few clock periods (the diagram illustrates a single clock cycle delay, due to internal pipeline stages). Similarly, port Y 78 will output its data as shown. The ports are internally programmed to output their data blocks serially (i.e. port X 77 followed by port Y 78), as the egress link from DMP0 79 is in this case shared by both DMP0 ingress ports (i.e. PP0 76 has been programmed to take account of this architectural implementation).
At a point during the transfer (i.e. t1 in the diagram), PP1 81 is programmed to start its internal processing of the ingress data block(s). The processing causes data growth, with the consequences that it takes longer to generate the results (i.e. 10 clocks) than it took to receive the ingress data (i.e. a total of 8 clocks), and it also produces larger quantities of data for each X 82 and Y 83 egress buffer (i.e. 6 words each).
If DMP1 84 is specified to use a single egress bus, it will take 12 clocks to forward the PP1 82, 83 egress data to PP2 87 (which is longer than the internal PP1 processing time), so DMP1 84 is designed to use 2 egress busses (i.e. X12 85 and Y12 86). This enables the PP1 82, 83 egress buffers to be transferred in parallel, in only 6 clocks (see busses X11 82, Y11 83, X12 85 and Y12 86). The transfer is started at point t2 during the PP1 processing operation, as specified by the PP 1 VLIW inputs.
PP2 87 will store the ingress data using internal addresses generated by its own address generator, as specified by the VLIW control inputs.

The progress of an individual word within a data block (e.g. Word 01 within the 4 word blocks described above) is as schematically illustrated in FIG. 13, as the data block is forwarded and processed by the pipeline planes. As shown in FIG. 13, the data word is represented as a thickened line.
Initially, the word is forwarded on bus X00 at time t0, as part of the block transfer between PP0 and DMP 0. Due to the internal pipeline delay within DMP 0 (i.e. a single clock cycle), the word will be forwarded on X01A after a clock cycle delay, at time t0+1 as shown.
Within PP1, the word will be processed at some time that depends on the internal functionality of PP1, and is shown as being accessed at time t0+7.
As a result of the processing within PP1, another word (or multiple words, not shown) may be forwarded on bus X11 (i.e. towards PP2) at a time shown as t0+15, where it is now part of a larger data block (i.e. 6 words).
Within DMP1, the word is again delayed by one pipeline clock cycle before being forwarded on bus X12.

Ingress Data Repetition Rates

It can be seen from FIG. 12 that the repetition rate for processing ingress data blocks is limited by the performance of PP1, as that plane requires the longest elapsed time (i.e. 10 clocks) to process a data block. Therefore the architectural limit for processing consecutive ingress data blocks (i.e. the block repetition rate) will be dictated by the plane that takes the longest elapsed time to either process or forward data blocks received from upstream. As discussed above and below, clock frequencies for controlling different stages in the pipeline can be set having regard to this bottleneck, either (or both) to minimise power consumption for a given throughput and to maximise the performance at those bottlenecks.

Data Transport Throughput Strategy

The operations involved in the architectural pipeline in FIG. 13 are not optimised across the architecture, in that some planes are idle for some intervals during a data processing cycle. The following points can be noticed in the timing diagram:
The architecture plane requiring the longest time to process blocks of data is PP1 (given that DMP 1 has been designed to be faster than PP1 when forwarding the resulting data), and therefore PP1 will dictate the pipeline throughput capability (i.e. the architecture block processing repetition rate, which is 10 clocks per block in this example).
PP0 and some buses are not fully utilised when processing or transferring data, and these could be optimised in several ways to increase the overall architectural efficiency (e.g. by reducing their performance to match the throughput capabilities of PP1).
The performance of all the planes can be optimised within an architecture for a given application. As mentioned previously, each PP contains optional internal clock boundaries to isolate the internal data processing domain from all data transfer operations. With this capability, it is possible to individually adjust the operating clock frequency of each domain in an optimal manner, as shown in FIG. 14, which schematically illustrates time domains across the pipeline.

In FIG. 14, timing domain 01 (which consists of reading the output buffers 88 from PP0 96, transferring the data via DMP0 97, and writing the data into the input buffers 90 in PP1 98) can operate using a clock frequency A, which can be unique to that domain and be selected to complete the data transfer at a rate which is just sufficient to match the processing capabilities of PP1 98. Similarly, a different clock frequency can be chosen for timing domain 12. Additionally, each PP can be assigned its own internal processing clock frequency, enabling the overall architecture to be closely optimised.

The strategies outlined above enable the following architectural advantages:
All pipeline stages can be dynamically matched for performance on an application basis.
Power can be reduced in planes which are not critical to the performance.
Radiated electromagnetic interference (EMI) peak power can be reduced, as each domain can be operated asynchronously, or have their clocks staggered by part of a clock period if the frequencies are the same.
Additionally, Spread Spectrum Clocking strategies can be implemented within the architecture. This technique modulates the clock frequency in a defined manner, so that the actual frequency changes slightly (i.e. by a specified small amount at a given rate) around the nominal frequency, to reduce EMI.

Architecture Inter-Plane Controls

Signals initiating data transfers between planes are utilised using two basic strategies, as schematically illustrated in FIG. 15:
Signals generated from a global pipeline control module 124;
Signals generated locally between an upstream (i.e. a data source) plane and a downstream (i.e. a data destination) plane.

If the entire pipeline is controlled globally, then all transfers will usually be synchronised within a single clock domain, as in the upper section of FIG. 15. Timing signals from a central pipeline control module initiate all transfers between planes, as described for a subset of the signals:
The transfer from PP0 117 on bus X00 108 is triggered by a signal 101 referenced as X00 at time t0, and the signal is also sent to DMP 0 118 to control any internal multiplexors;
The Y00 bus transfer is similarly controlled;
Signals X01A 103 and X01B 104 are sent to PP1 119, to indicate the start of the transfers from DMP 0.

The advantage of this clocking strategy is its simplicity, as all transfers take place within a single pipeline clock domain. However, in some applications, it may be simpler or necessary to use local signals to initiate transfers between adjacent planes, as shown in 125, where both local and global controls are utilised. With this clocking strategy, a global signal initiates a transfer within a PP (e.g. X00 108 in PP0 117). Separate local control signals will then be forwarded in parallel with the data through the pipeline, and used to control the downstream planes.

The asynchronous interfaces within PPs can also be used with the locally generated pipeline transfer mechanism. In this case, a global signal issued to a PP will be asynchronously transferred to a separate clock domain (e.g. timing domain 01 in FIG. 14), and used within that domain to generate the local control signals. When the transfer is completed, the following PP will be triggered to process the data by a final signal being asynchronously transferred to its internal clock domain. The strategy is illustrated using the “async” arrows in FIG. 15. This enables the clock controlling the timing domain 01 to be set to an optimum clock frequency, providing the architectural benefits described previously (e.g. reduced power and EMI).

Application Operations

The previous sections outlined generic strategies for processing and moving data through the pipelined planes within an architecture. This section describes specific operations that may be involved in an application, to illustrate the flexibility of the architecture.

As data moves through an architecture, several issues can arise:
The time taken to process the data block samples at a particular pipeline stage can be greater than the data block transfer time (i.e. processing growth);
The amount of data produced by a particular processing stage can be greater than the input data block sample size (i.e. data growth); and
Dependencies can arise between the different data streams in the SIMD architecture.

These issues require varying capabilities between planes at different stages in the pipeline, and some solutions for these requirements using the proposed architecture are described here.

Processing Growth

An example of processing data growth is a Fast Fourier Transform (FFT) operation, where an input data block requires multiple iterations of processing before the results can be forwarded. This requires a PP where each PE contains additional internal storage to hold temporary intermediate results before forwarding the final processed data block, as schematically illustrated in FIG. 16.

The FFT processing algorithm will be illustrated for a data block size of 8 samples (i.e. containing data samples [7:0]). The number of data processing iterations is proportional to the logarithm of the block size, so 3 processing iterations on the data samples will be necessary before the results can be forwarded. A more realistic block size of 128 samples would require 7 processing stages. To provide an FFT solution, each input data block will require a matching internal PE buffer containing constants which will be used by the processing algorithm, and a buffer to hold intermediate results from each processing stage of the algorithm. Additional internal logic (e.g. address generation logic or ALU multipliers) is not explicitly shown.

The algorithm requires the following processing actions:
An address generation sequencer 135 is required, supplying address sequences that are specific to each processing stage of the FFT.
During the 1st data processing stage, a pair of input data samples are selected from the ingress port 129 buffer 126, and multiplied in a defined set of ALU 133 operations (i.e. referred to as a butterfly operation) with a pair of constants obtained from the constants buffer 132. The results are written to a pair of locations in the temporary results buffer 134.
This butterfly operation will be performed a total of 4 times (i.e. N/2 times), covering all the input data samples.
The 2nd processing iteration performs another 4 butterfly operations, this time using data in the temporary buffer 134 and the constants buffer 132 as input operands, and writing the results back to the temporary buffer 134.
The 3rd (i.e. final) processing iteration uses data in the temporary buffer {134} and the constants buffer 132 as butterfly input operands, and writes the results to the output data buffer 128 on port X 131.

Having completed the final data processing stage, the PP can forward the results to the next plane. The output data block 128 contains the same number of elements as the ingress data block 126.

In this application, the PE requires two additional internal buffers, each containing the same number of locations as the data block size. Processing time will be proportional to the number of processing stages, and the architecture can be tailored to take account of that time when transferring data blocks to or from the PP.

Inter-Stream Growth

Inter-stream growth issues emerge where the results of processing an individual data stream (within the SIMD architecture) must be forwarded to each of the other downstream PEs in the pipeline for further processing, as shown in FIG. 17, which schematically illustrates the connectivity to enable sequential transfers (i.e. from upstream PE 140 ports X 139) for multiple individual data streams.

A similar transfer capability may also be required from other PP ports (e.g. ports Y 143 to ports B 144), potentially taking place simultaneously with the port X 139 transfers. That would require a separate bus network, which is not shown in the diagram for clarity. Each upstream PE 140 in PP0 136 transfers a data block to the DMP 137 in turn, which then forwards the data block to each downstream PE 142 in PP1 138 in parallel.

Control Word Operation

The operation of the individual PPs and DMPs in the architecture pipeline is controlled by dedicated fields within a VLIW, as shown schematically in FIG. 18. The VLIW itself will be generated from a central module (described above) that specifies how the architecture is to be tailored for a particular application.

VLIW Control Fields Distribution

The control field 145 for a given plane can be distributed to the elements in the plane using a number of implementation strategies, as shown in FIG. 18: —
Control fields may be distributed using a parallel bus, or a field may be serialized before being distributed.
A control field can optionally contain an address 146, 147, 148, to activate only a specific element or group of elements within a plane.
The control field 146 for PP0 149 is shown as being distributed directly to each element in the plane.
The control field 147 for DMP0 150 is shown as being distributed within the plane using a single loop which straddles all the elements in the plane (e.g. a large shift register). The control field will be sent multiple times such that each element receives a copy of the field, unless a specific element is addressed.
The control field 148 for PP1 151 is forwarded to a decoder 152, which only forwards the control field to the addressed elements.

Each strategy results in trade-offs between (e.g.) latency and area, and implementation strategies will be chosen to optimize the architecture. The implementation options listed above are not the only possible scenarios but illustrate some of the principles and motivating factors.

### Control Field Operation Example

The flexibility of the control field operations is illustrated schematically in the example shown in FIG. 19, where row and column state machines are used to control the operation of groups of elements within the plane. In FIG. 19, the input control field 153 is modified 154-7 for each row and column before being forwarded to the appropriate elements. The combination of the modified row and column control field inputs are used to control the operation of the elements using internal state machines, labelled as SM-i state machines 158-161 in the diagram. Within each element, the SM-i state machines 158-161 generate all control sequences and signals required for the element operation. The control field can operate on an entire plane, or individually control rows or columns by using row or column state machines. In the latter case, this means that different processing elements within a processing plane can step through the plurality of data processing operations specified in the control field of the VLIW corresponding to that processing plane independently of each other. In other words, this strategy enables any desired subset of the PEs in a plane to operate independently of other subsets within the same plane.

Application Strategies

Similarly to the operation of an FGPA system, prior to real-time use the functions of the processor will be set using the VLIW and used unchanged for the duration of the task. The system permits the option, if necessary, to alter elements of the VLIW during use at the cost of increasing algorithmic complexity and data management requirements. During operation, the control field for a particular plane (e.g., a PP) will be decoded locally within that plane to process data blocks, using one of the following strategies:
A PP will have a decoder (or multiple decoders) controlled by its VLIW field. The decoder(s) will generate any required control sequences (i.e. PE addresses or control signals), and distribute these to an appropriate set of PEs in the PP.
Each PE in the PP will generate all PE internal sequences directly from the VLIW field, using an internal decoder.

The choice will depend on the application, or on the implementation efficiency.

Multiple Applications

An architecture may be designed to support more than one application. In those circumstances, trade-offs will be made at both the architectural level and the plane level to optimise the overall design. The rate at which the architecture switches between applications is not inherently limited by the design, and is limited only by the rate at which VLIW fields can be updated. The update rate is a design parameter that can be chosen to meet the application requirements. It is possible that hybrid implementations could be produced which have different update behaviours or update rates for particular regions of the device in order to meet the requirements of specific applications.

The architecture is designed to be flexible enough to accommodate a range of algorithmic implementations and can be applied to procedures that benefit from key algorithmic building blocks including channelization, matrix mathematics, correlation, FFT and iFFT. This will be generically useful where parallel data streams are used, examples being cryptography, parallel data processing or bitcoin mining. Some examples of specific applications follow:

Beamforming example

$$Y ( n ) = {\sum }_{i = 0}^{i = N - 1} Wi \cdot Xi ( n )$$

i=0, 1, 2, 3 (for N=4 inputs, 0 to N−1)
Xi are the output samples from the PEs in PP0 at sample time (n)
Wi are the complex weighting factors used to modify each input sample to the PEs in PP1
Y(n) is the result of the beamformer calculation at sample time (n)

As shown in FIG. 17, an output from each PE in PP0 is sent sequentially to each PE in PP1, and this will enable a separate beamforming calculation to be performed within each PE in PP1. Different weighting factors can be stored within each PE in PP1, enabling 4 different beamforming calculations to be performed in parallel within the architecture. An example sequence of transfers to perform the beamforming operation is shown schematically in FIG. 20. It can be seen that it takes a minimum of 4 clock cycles to transfer the required data samples from PP0 to PP1, for a given beam calculation. Therefore each PE in PP0 only needs to provide data samples at a reduced rate (i.e. a sample every 4 clocks, although the data sample will be transferred during a different clock cycle from each PE in PP0). Within each PE in PP1, 4 complex multiplications and a complex addition must be performed within the samples transfer time (i.e. 4 clocks). The means of achieving this functionality will be an implementation decision.

Cellular Base Station

Simple linear arrays are already in use in the cellular base station market, and they typically employ very simple beamforming techniques in order to resize the cell. A more sophisticated cellular base station could be implemented using the same front end RF infrastructure which facilitates many improved modes of operation, including multiple “Virtual Cells” from a single installation, Directed Cells to focus coverage into hard to reach physical locations, Dynamic physical tracking of user demand and Dynamic Cell Granularity.

Audio Applications

The technology enables high resolution 3D audio systems to be realized. Previous phased array audio systems typically rely on time domain delay based phase control resulting in sub optimal audio performance. The technology described herein allows finer grained control of phase for each frequency component of the audio signal to compensate for group delay or frequency smearing. The technology can also be deployed in microphone arrays and as part of a closed loop system may be employed to implement self-equalizing of ‘difficult’ performance environments such as Churches, Outdoor Arena's and Public Spaces. This reduces setup time, and manpower requirements therefore reducing costs to the PA system vendor. The technology allows the placement of Audio null zones around the Performance environment. This is of particular relevance in outdoor performance where Environmental Health legislation requires limited hours available for performance.

Satellite Communications Systems Application

The capability to create multiple simultaneous beams allows the technology described herein to be deployed as a unique system component in a multi service mobile satellite terminal system. A single antenna, LNB, IF infrastructure can be employed to connect to spatially separated satellites. This allows provision of a triple play mobile satellite terminal system offering TV, Internet & Telephony services from a single Antenna Array front end.

Other Applications

There is also potential for the architecture to be used in conjunction with a microcontroller to manage coefficients from an external source directed via (e.g.) Ethernet. This could have use in radio/telecommunications traffic management to create and manage virtual cells. Work on bandwidth management in 5G would also be relevant. Some embodiments also have potential scientific uses in telescopy, processing distributed aperture array systems such as the Square Kilometer Array (SKA) or other related radio astronomy uses. Further applications include use in a passive-mm security scanner, which would involve a raster scan of a zone, injecting coefficients, breaking zone into small blocks to focus receiver, and measurement/reconfiguration by dynamic updates. In general many defense systems which rely on fast and efficient signal processing would likely benefit.

Summary of Key Points:

Core Architecture
Each Processing Element (PE) contains an Arithmetic Logic Unit (ALU) which is preceded by and followed by a Queue comprising data registers.
The Queue can be many data words in depth.
Alongside the Queue there is a Coefficient Table, which determines the coefficient that will be applied to any given data operand as it enters the ALU.
The PE arrays are linked by the Data Movement Planes (DMPs).
The intelligence in the system is implemented by the combination of the PEs and the DMPs.
The transfer of data between the PE arrays (via the DMPs) is carried out in synchronisation by a master system clock which sets the ‘Frame Rate’.
The time necessary to implement the interconnecting function will be designed not to be system critical so clock phase offsets, clock dithering and Spread Spectrum Clocking can be implemented in order to control and reduce dynamic current loads, and improve the emitted RFI performance of the system or device.
Each Processing Plane (PP) contains optional internal clock boundaries to isolate the internal data processing domain from all data transfer operations. With this capability, it is possible to individually adjust the operating clock frequency of each domain in an optimal manner.
The structure of implementation with multiple SIMD (Single Instruction, Multiple Data) planes on one chip only makes sense when there is a sensible way to link the planes. The combination of the SIMD planes with DMPs makes this feasible.
The use of a VLIW (Very Long Instruction Word) to control the sequencing of the Processing and associated Data Movement structures in order to create efficient pipeline processing structures.
Data within the system is inherently coherent through the use of the VLIW, so there is no overhead for synchronising the system. This leads to system simplification and cost reduction.
In a system such as this where multiple PEs in a plane are cross-connected with the same number of elements in the subsequent plane, and multiple planes exist in the system, there is scope for an explosion of data within the system. However, the particular design of this system is such that the VLIW applied to any particular PP and DMP will only generate data that is needed by the subsequent processing stage. Therefore, system complexity is managed and cost/power consumption are optimised.
PE connections can be rotated between PEs in the different PPs, allowing multiple levels of multiplexing within the DMP.
The use of simple state driven PEs combined with a mode controlled interconnect fabric enables the efficient implementation of a specific class of processing problems. Dynamic Data Movement Capability
The capabilities built into the DMPs mean that the PEs can be simplified, with data routing functionality being moved to the DMPs. This leads to less duplication of circuitry within a chip; and less interconnect being driven within the system, which means reduced power consumption and higher functionality per device.
The DMPs provide a capability for switching, data transfer and data formatting, and the additional impact of such a configurable element in the cross connect path is that the system can be programmed in two ways:
   Through the interconnect configuration code of the VLIW, that determines the operation of each DMP within the overall architecture pipeline.
   Through the selection of appropriate coefficients in the coefficient table, the passage of data from PE to PE can also be controlled.
Each plane in the architecture will initiate a block of data transfers when triggered to do so, and each plane (PP or DMP) will also independently generate all internal control sequences required to perform the data transfer (as specified by the VLIW control inputs).

1. A data processor, comprising:
a sequence of processing stages, each processing stage comprising a plurality of processing elements, each processing element comprising an arithmetic logic unit, one or more input data buffers and one or more output data buffers, the arithmetic logic unit being operable to conduct a data processing operation on one or more values stored in an input data buffer and to store the result of the data processing operation into an output data buffer;
between each pair of processing stages in the sequence, an interconnect, for conveying data values stored in the output data buffers of the processing elements in a first one of the processing stages in the pair to the input data buffers of the processing elements in the next processing stage in the pair; and
a controller, operable to specify, in respect of each processing stage, a data processing operation to be carried out by the processing elements in that processing stage, and to specify, in respect of each interconnect, a routing from one or more of the output data buffers of one or more of the processing elements of the processing stage from which the interconnect is receiving data to one or more of the input data buffers of one or more of the processing elements of the processing stage to which the interconnect is conveying data,
wherein the controller is responsive to an instruction word to specify the data processing operation for each processing stage and the routing for each interconnect, the instruction word comprising a control field for each processing stage indicating a data processing operation to be carried out by that processing stage, and a routing field for each interconnect indicating a routing operation for routing data between the processing stages connected by the interconnect,
and wherein each control field specifies a sequence of data processing operations to be carried out by the processing elements in the plane to which the control field corresponds, and each routing field specifies a sequence of routing operations to be carried out by the interconnect to which the routing field corresponds.

2. A data processor according to claim 1, wherein the controller is operable to specify, in respect of each interconnect, one or more bit level manipulations of the data being conveyed by the interconnect, and the interconnect is operable to perform the bit level manipulations specified by the controller on data received by the interconnect before conveying the manipulated data to the processing stage to which the interconnect is conveying data.

3. A data processor according to claim 2, wherein the bit level manipulations are data processing operations which do not use data external to the interconnect.

4. A data processor according to claim 2, wherein the bit level manipulations comprise one or more of inversion of one or more bits of a data word, setting a first portion or a last portion of a data word to zero, and shifting one or more bits of a data word in the direction of the most significant bit or the least significant bit of the data word.

5. A data processor according to claim 1, wherein each routing field specifies a sequence of bit level manipulations to be carried out by the interconnect to which the routing field corresponds.

6. A data processor according to claim 1, comprising an input interface via which input data values are provided to the sequence of processing stages, and an output interface via which output data values from the plurality of processing stages are output from the sequence of processing stages, the input interface being connected to a first of the processing stages in the sequence via an interconnect, and the output interface being connected to a last of the processing stages in the sequence via an interconnect;
wherein the controller specifies a routing from one or more elements of the input interface to one or more of the input data buffers of one or more of the processing elements of the first processing stage, and a routing from one or more of the output data buffers of one or more of the processing elements of the last processing stage to one or more elements of the output interface.

7. A data processor according to claim 1, wherein the input buffers and the output buffers each store a plurality of words of data, the arithmetic logic units being operable to perform the data processing operation on one or more data words in an input buffer and to store the result of the data processing operation as one or more data words in the output buffer.

8. A data processor according to claim 1, wherein at least some of the processing elements comprise a temporary storage buffer, to which the arithmetic logic unit is able to store an intermediate result of a data processing operation, and from which the arithmetic logic unit is able to obtain an intermediate result in order to carry out a next stage of a data processing operation.

9. A data processor according to claim 1, wherein at least some of the processing elements comprise a constants buffer containing data values which are not obtained from a previous processing stage and are not generated by a data processing operation of the current processing stage, the arithmetic logic unit being operable to perform the data processing operation using one or more values from the constants buffer.

10. A data processor according to claim 9, wherein the constants buffer is populated with constants received from an external source.

11. A data processor according to claim 1, wherein each interconnect is operable to receive data values in parallel from a plurality of output buffers of a processing element of a source processing stage, and to provide those data values sequentially to one or more input buffers of a processing element of a target processing stage.

12. A data processor according to claim 1, wherein each interconnect comprises a greater number of input data connections than output data connections, and wherein the interconnect is operable to time multiplex input data onto the output data connections.

13. A data processor according to claim 1, wherein each interconnect comprises a greater number of output data connections than input data connections.

14. A data processor according to claim 1, wherein each interconnect is able to convey data from any output data buffer of any processing element of a first stage to any input data buffer of any processing element of a second stage.

15. A data processor according to claim 1, wherein the timing of each processing stage is driven by a stage-specific clock, the clock frequency of each processing stage being independently adjustable.

16. A data processor according to claim 1, wherein different ones of the processing stages are driven at different clock frequencies.

17. A data processor according to claim 1, wherein different ones of the interconnects are driven at different clock frequencies.

18. A data processor according to claim 1, wherein one or more of the processing stages are driven at a different clock frequency than one or more of the interconnects.

19. A data processor according to claim 1, wherein different parts of a processing stage are driven at different clock frequencies.

20. A data processor according to claim 1, wherein data is conveyed by an interconnect to a processing stage at a first clock frequency, the conveyed data is processed by the processing stage at a second clock frequency, and the processed data is retrieved from the processing stage at a third clock frequency, wherein the first, second and third frequencies are not all the same.

21. A data processor according to claim 22, wherein the first, second and third clock frequencies are set such that the rate at which data is provided to the processing stage substantially matches the rate at which the data is processed by the processing stage, and such that the rate at which data is retrieved from the processing stage substantially matches the rate at which processed data is generated by the processing stage.

22. A data processor according to claim 1, wherein a clock frequency for controlling the reading of data from the output buffers of a first processing stage, transferring the data from the first processing stage to a second processing stage and writing the transferred data into the input buffers of the second processing stage is set such that the data is transferred from the output buffers of the first processing stage to the input buffers of the second processing stage at a rate which is just sufficient to match the rate at which the data is being processed by the second processing stage.

23. A data processor according to claim 1, wherein the timing of data transfers across the interconnects is triggered globally within a common clock domain.

24. A data processor according to claim 1, wherein the timing of data transfers is controlled by local timing control signals which are forwarded in parallel with data.

25. A data processor according to claim 1, wherein an interconnect is operable to begin transferring data from a first processing stage to a second processing stage before the first processing stage has completed the data processing operation.

26. A data processor according to claim 1, wherein a second processing stage is operable to begin a data processing operation on data received via an interconnect from a first processing stage before the transfer of data from the first processing stage to the second processing stage has completed.

27. A data processor according to claim 1, wherein the controller is operable to route a data value stored in an output buffer of a processing element of a first processing stage to an input buffer of a plurality of processing elements of a second processing stage.

28. A data processor according to claim 1, wherein the controller is selectably controllable by an internal or external source.

29. A data processor according to claim 1, wherein the controller is responsive to exception conditions generated at one or more of the processing stages and/or interconnects to control the handling of the exception.

30. A microprocessor architecture comprising a data processor according to claim 1.

31. A method of processing data through a sequence of processing stages, each processing stage comprising a plurality of processing elements, each processing element comprising an arithmetic logic unit, one or more input data buffers and one or more output data buffers, the method comprising the steps of:
at an arithmetic logic unit in a first one of a pair of processing stages, conducting a data processing operation on one or more values stored in an input data buffer and to store the result of the data processing operation into an output data buffer;
using an interconnect provided between each pair of processing stages in the sequence, conveying data values stored in the output data buffers of the processing element in the first one of the processing stages in the pair to the input data buffers of a processing element in the next processing stage in the pair;
specifying, in respect of each processing stage, a data processing operation to be carried out by the processing elements in that processing stage;
specifying, in respect of each interconnect, a routing from one or more of the output data buffers of one or more of the processing elements of the processing stage from which the interconnect is receiving data to one or more of the input data buffers of one or more of the processing elements of the processing stage to which the interconnect is conveying data;
responding to an instruction word to specify the data processing operation for each processing stage and the routing for each interconnect, the instruction word comprising a control field for each processing stage indicating a data processing operation to be carried out by that processing stage, and a routing field for each interconnect indicating a routing operation for routing data between the processing stages connected by the interconnect; and
specifying, in respect of each control field, a sequence of data processing operations to be carried out by the processing elements in the plane to which the control field corresponds, and specifying, in respect of each routing field, a sequence of routing operations to be carried out by the interconnect to which the routing field corresponds.

32. A computer program which when executed on a data processing apparatus causes the data processing apparatus to perform the method of claim 31.

33. (canceled)

34. (canceled)
